(19) United States
(12) Patent Application Publication
(10) Pub. No.: US 2026/0312119 A1
(43) Pub. Date: Oct. 8, 2026

(54) SYSTEMS, DEVICES, AND METHODS FOR A VARIABLE COMPRESSION BATTERY CELL PACK FOR A VEHICLE

(71) Applicant: Toyota Motor Engineering & Manufacturing North America, Inc., Plano, TX (US)

(72) Inventor: Juan A. Velasco, Ypsilanti, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/169,927

(22) Filed: Apr. 3, 2025

(51) Int. Cl. H01M 10/04; H01M 10/48; H01M 50/24; H01M 50/249; H01M 50/264

(52) U.S. Cl. CPC H01M 10/0481; H01M 10/482; H01M 10/486; H01M 50/24; H01M 50/249; H01M 50/264; H01M 2220/20

(57) ABSTRACT

Systems, devices, and methods for expanding and contracting compression on battery cells in a vehicle. The system may include battery cells in a cell stack and a variable compression mechanism. The system also may include a battery pack and a plurality of pressure sensors. The system also may include an electronic control unit (ECU) configured to (1) receive a compression setting for the plurality of battery cells, (2) receive a pressure reading from the plurality of sensors, (3) determine a compressive load input based on the compression setting and the pressure reading, (4) when the load input indicates to increase compressive load exerted on the cells, cause the machine press to expand to compress the plurality of battery cells, and (5) when the load input indicates to decrease compressive load exerted on the cells, cause the machine press to retract to decompress the plurality of battery cells.

### BACKGROUND

### 1. Field

The present disclosure relates to systems, devices, and/or methods for a variable compression battery cell pack and module design for a vehicle.

### 2. Description of the Related Art

Certain vehicles, such as battery electric vehicles (BEVs), plug-in hybrid electric vehicles (PHEVs), and/or hybrid electric vehicles (HEVs), may include a battery housed within a battery case. Generally, the battery case is meant to (among other things) house and protect the battery. However, prismatic battery cells in BEVs and PHEVs can expand and contract during charge and discharge. As a result, the cells must be compressed to a designated minimum and maximum value, which can vary based on the type of cell and application. Currently, existing methods for achieving these compression loads include making the battery cells part of a module with metal bands that act as springs or by installing the cells directly into a pack and using the pack rigidity to achieve compression. However, both methods rely on the rigidity of the module bands or pack structure to apply compression forces. The resultant forces acting on the cells then become a direct reaction to the cell's expansion and are limited by the material properties and mechanical design of the module and pack.

Accordingly, it is desirable to provide systems, devices, and methods for a variable compression battery cell pack and module design for a vehicle.

### SUMMARY

Described herein is a system for expanding and contracting compression on battery cells in a vehicle. In one aspect, the system may include a plurality of battery cells in a cell stack. The system also may include a variable compression mechanism. The variable compression mechanism may include a machine press configured to expand and retract to compress and decompress one or more battery cells based on a compressive load, and an end plate configured to evenly distribute the load over a surface area of the one or more battery cells, the machine press being connected to the end plate, and the end plate being mounted to the one or more battery cells. The system also may include a battery pack formed in the shape of a rectangle and defining a cavity for holding the cell stack and the variable compression mechanism. The system also may include a plurality of sensors coupled to the cell stack and the variable compression mechanism configured to detect pressure on the cell stack. The system also may include an electronic control unit (ECU) electronically connected to the cell stack, the variable compression mechanism, and the plurality of sensors. The ECU is configured to (1) receive a compression setting for the plurality of battery cells, (2) receive a pressure reading from the plurality of sensors, (3) determine a compressive load input based on the compression setting and the pressure reading, the load input indicating to increase or decrease compressive load exerted on the cells, (4) when the load input indicates to increase compressive load exerted on the cells, cause the machine press to expand to compress the plurality of battery cells in the cell stack, and (5) when the load input indicates to decrease compressive load exerted on the cells, cause the machine press to retract to decompress the plurality of battery cells in the cell stack.

In one aspect, the subject matter may be embodied in a variable compression battery cell pack for a vehicle battery in a vehicle. The cell pack may include a plurality of battery cells in a cell stack. The cell pack also may include a variable compression mechanism. The variable compression mechanism may include a machine press configured to expand and retract to compress and decompress one or more battery cells based on a compressive load, and an end plate configured to evenly distribute the load over a surface area of the one or more battery cells, the machine press being connected to the end plate, and the end plate being mounted to the one or more battery cells. The cell pack also may include a battery pack formed in the shape of a rectangle and defining a cavity for holding the cell stack and the variable compression mechanism. The cell pack also may include a sensor coupled to the cell stack configured to detect pressure on the cell stack. The cell pack also may include an electronic control unit (ECU) electronically connected to the cell stack, the variable compression mechanism, and the sensor. The ECU is configured to (1) receive a compression setting for the plurality of battery cells, (2) receive a pressure reading from the sensor, (3) determine a compressive load input based on the compression setting and the pressure reading, the load input indicating to increase or decrease compressive load exerted on the cells, (4) when the load input indicates to increase compressive load exerted on the cells, cause the machine press to expand to compress the plurality of battery cells in the cell stack, and (5) when the load input indicates to decrease compressive load exerted on the cells, cause the machine press to retract to decompress the plurality of battery cells in the cell stack.

In one aspect, the subject matter may be embodied in a vehicle including a system for expanding and contracting compression on battery cells in the vehicle. The system may include a plurality of battery cells in a cell stack. The system also may include a variable compression mechanism. The variable compression mechanism may include a machine press configured to expand and retract to compress and decompress one or more battery cells based on a compressive load, and an end plate configured to evenly distribute the load over a surface area of the one or more battery cells, the machine press being connected to the end plate, and the end plate being mounted to the one or more battery cells. The system also may include a battery pack formed in the shape of a rectangle and defining a cavity for holding the cell stack and the variable compression mechanism. The cell stack may be positioned in the battery pack between a rigid member and the variable compression mechanism. The system also may include a plurality of sensors coupled to the cell stack and the variable compression mechanism configured to detect pressure on the cell stack. The system also may include an electronic control unit (ECU) electronically connected to the cell stack, the variable compression mechanism, and the plurality of sensors. The ECU is configured to (1) receive a compression setting for the plurality of battery cells, (2) receive a pressure reading from the plurality of sensors, (3) determine a compressive load input based on the compression setting and the pressure reading, the load input indicating to increase or decrease compressive load exerted on the cells, (4) when the load input indicates to increase compressive load exerted on the cells, cause the machine press to expand to compress the plurality of battery cells in the cell stack, and (5) when the load input indicates to decrease compressive load exerted on the cells, cause the machine press to retract to decompress the plurality of battery cells in the cell stack.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram illustrating a vehicle having a system for expanding and contracting compression on battery cells in a vehicle according to an aspect of the disclosure.

FIG. 2 is a schematic of an example vehicle with which an example variable compression battery cell pack may be implemented according to an aspect of the disclosure.

FIGS. 3 and 4 are cross-sectional views of example variable compression battery packs according to an aspect of the disclosure.

FIG. 5 is a cross-sectional view of an example alternate variable compression mechanism for vehicle battery cells according to an aspect of the disclosure.

FIG. 6 is a cross-sectional view of a portion of the example variable compression mechanism of FIG. 5 according to an aspect of the disclosure.

FIG. 7 is a top view of a portion of the example variable compression mechanism of FIG. 5 according to an aspect of the disclosure.

FIG. 8 is a flowchart illustrating an example process for expanding and contracting compression on battery cells in a vehicle according to an aspect of the disclosure.

### DETAILED DESCRIPTION

Disclosed herein are systems, devices, vehicles, and/or methods for implementing a variable compression mechanism for battery cells in a vehicle. The variable compression mechanism may include a mechanical or hydraulic press that can expand and contract to compress the cells in the pack based on a compressive load input. The press may be mounted to an end plate, which is positioned between the cells and the press, that can evenly distribute the load over the whole surface area of a prismatic cell. The cell stack may sit in the pack with one side against a rigid member (e.g., the frame of the cell pack) and the other side against the variable compression mechanism (e.g., the end plate and press). When the press is extended, the compressive load exerted on the cells may increase. On the other hand, when the press is retracted, the compressive load on the cells may decrease. Particular embodiments of the subject matter described in this disclosure may be implemented to realize one or more of the following advantages.

Currently, existing systems may use prismatic modules in BEV and PHEV applications that use steel bands to restrain the cells during charge and discharge cycles, which may cause the cells to expand. In these cases, the compression amount is dictated by the mechanical properties of the band material and cell expansion. The present system would allow for the cells to be mounted directly to a battery pack that could control variable compression forces as an input and not a result of pack operation. For example, the variable compression system may be controlled by an electronic control unit (ECU) that can apply loads via the variable compression mechanism based on predetermined settings (e.g., a minimum or maximum load) for each individual cell. Therefore, one pack could accept different types of prismatic cells without needing as much redevelopment of pack components for each different type of cell.

Furthermore, the present system would allow the cells to be mounted directly into the pack, as opposed to existing systems that rely on bands to secure the cells. Directly mounting the cells into the pack would allow for cell compression to be a direct input (e.g., via the ECU) based on the individual performance needs of the cell being used. Being able to actively control compressive forces on cells can accordingly minimize lithium deposition and, as a result, reduce fast charging time for the battery. In addition, the life of the cell could also be increased by optimizing compressive forces during the cell's lifespan.

Described herein is a system for expanding and contracting compression on battery cells in a vehicle. In one aspect, the system may include a plurality of battery cells in a cell stack. The system also may include a variable compression mechanism. The variable compression mechanism may include a machine press configured to expand and retract to compress and decompress one or more battery cells based on a compressive load, and an end plate configured to evenly distribute the load over a surface area of the one or more battery cells, the machine press being connected to the end plate, and the end plate being mounted to the one or more battery cells. The system also may include a battery pack for holding the cell stack and the variable compression mechanism. The system also may include a plurality of sensors configured to detect pressure on the cell stack. The system also may include an electronic control unit (ECU) electronically connected to the cell stack, the variable compression mechanism, and the plurality of sensors. The ECU is configured to (1) receive a compression setting for the plurality of battery cells, (2) receive a pressure reading from the plurality of sensors, (3) determine a compressive load input based on the compression setting and the pressure reading, the load input indicating to increase or decrease compressive load exerted on the cells, (4) when the load input indicates to increase compressive load exerted on the cells, cause the machine press to expand to compress the plurality of battery cells in the cell stack, and (5) when the load input indicates to decrease compressive load exerted on the cells, cause the machine press to retract to decompress the plurality of battery cells in the cell stack.

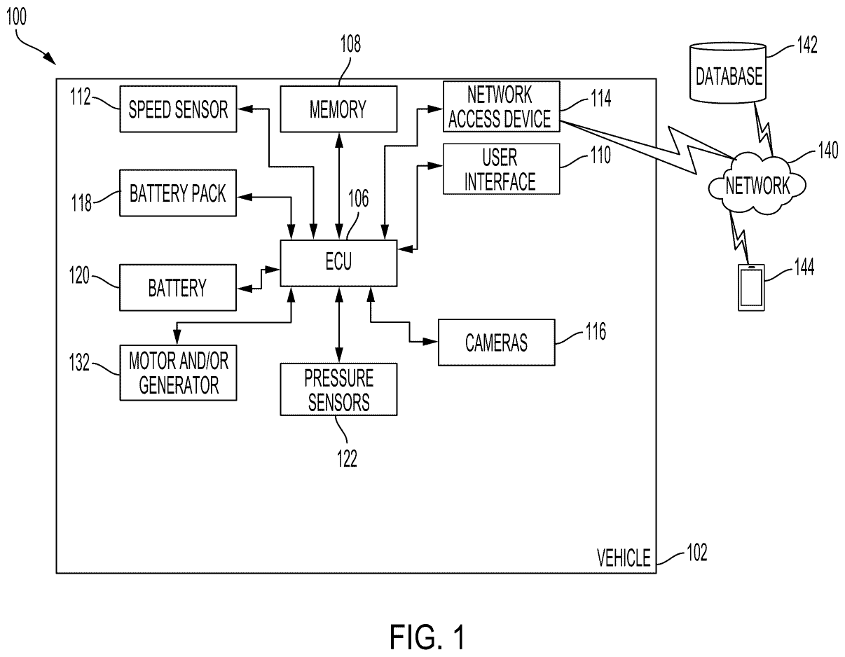

FIG. 1 is a block diagram for an example variable compression battery pack system 100. The variable compression battery pack system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or other motor, battery, or fuel cell driven vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The variable compression battery pack system 100 and/or the vehicle 102 may include a motor and/or generator 132 and/or a battery 120. The battery 120 may be housed within a battery pack 118. The motor and/or generator 132 may be located within an engine bay of the vehicle 102. For example, the motor and/or generator 132 may be an internal combustion engine (ICE). In this regard, the motor and/or generator 132 may combust an air and fuel mixture to provide power to the vehicle 102 and/or components of the vehicle 102 and/or the variable compression battery pack system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor, such as for battery electric vehicle (BEV) applications, for example. In this regard, the motor and/or generator 132 may be an electric motor and an electric generator that converts electrical energy into mechanical power, such as torque, and converts mechanical power into electrical energy. The motor and/or generator 132 may be electrically connected to the battery 120. The motor and/or generator 132 may convert energy from the battery 120 into mechanical power, and may provide energy back to the battery 120, for example, via regenerative braking. The battery 120 may be electrically connected to the motor and/or generator 132 and may provide electrical energy to and/or receive electrical energy from the motor and/or generator 132. The battery 120 may provide electrical energy to the variable compression battery pack system 100.

The variable compression battery pack system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the variable compression battery pack system 100 (e.g., via a controller area network (CAN) bus and/or other protocols). For example, the ECU 106 may be electrically connected to one or more pressure sensors 122, the motor and/or generator 132, the battery 120, a memory 108, a user interface 110, a network access device 114, a speed sensor 112, one or more cameras 116, and/or a battery pack 118. The ECU 106 may include one or more processors (or controllers) specifically designed for controlling operations of the vehicle 102, such as accelerating, braking, autonomous driving, parking (or parking assistance), etc. Moreover, the ECU 106 may control a panoramic view monitor (PVM) of the vehicle 102 (e.g., including the user interface 110 and/or the one or more cameras 116). In examples, the ECU 106 may be and/or include an ADAS sensor fusion ECU, a PVM ECU, an engine control module (ECM), a transmission control module (TCM), a telematics control unit (TCU), an inertial measurement unit (IMU), an in-vehicle infotainment (IVI) ECU, a graphics processing unit (GPU), and/or an artificial intelligence (AI) chip or processor.

The variable compression battery pack system 100 may further include the memory 108. The memory 108 may be electrically connected to the ECU 106. In examples, the memory 108 may be communicatively coupled (e.g., via a network 140 and/or the network access device 114) to the ECU 106 such that the memory 108 is remote from the ECU 106 and/or the vehicle 102. In other examples, the memory 108 may be electrically connected to the ECU 106 and a remote memory (e.g., a remote database 142) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle and/or battery parameters (e.g., a weight of the vehicle 102, dimensions of the vehicle 102, transmission gear information of the vehicle 102, battery cell type of the battery 120, etc.).

The variable compression battery pack system 100 may further include the user interface 110. The user interface 110 may be located within a cabin of the vehicle 102 (e.g., coupled to a dashboard of the vehicle 102). The user interface 110 may provide an interface to a user of the vehicle 102 (e.g., a driver and/or a passenger of the vehicle 102) to interact with and/or receive output from the ECU 106. The user interface 110 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The variable compression battery pack system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a Dedicated Short Range Communications (DSRC) unit, a satellite network unit, and/or a cellular network unit for accessing the network 140 (e.g., CDMA, GSM, 3G, 4G, 5G, etc.). The network access device 114 may transmit data to and receive data from devices and systems not directly connected to the vehicle 102. For example, the ECU 106 may communicate with the remote database 142 and/or a user device 144 (e.g., a mobile device, a phone, a tablet, a laptop, etc.) through the network access device 114.

The variable compression battery pack system 100 may further include the speed sensor 112. In examples, the variable compression battery pack system 100 may include a plurality of speed sensors. The speed sensor 112 may be electrically connected to the ECU 106. The speed sensor 112 may be configured to measure, detect, and/or determine the current speed of the vehicle 102. For example, the speed sensor 112 may be and/or include an electronic vehicle speed sensor (e.g., that measures rotation of the motor and/or generator 132 and/or a transmission shaft of the vehicle 102) and/or one or more wheel speed sensors (e.g., that measure rotation of one or more wheels of the vehicle 102). In examples, the speed sensor 112 may provide speed data indicating the current speed of the vehicle 102 to the ECU 106. The ECU 106 and/or the speed sensor 112 may determine the current speed of the vehicle 102 (e.g., in miles per hour (MPH) and/or kilometers per hour (KPH)) based on the speed data.

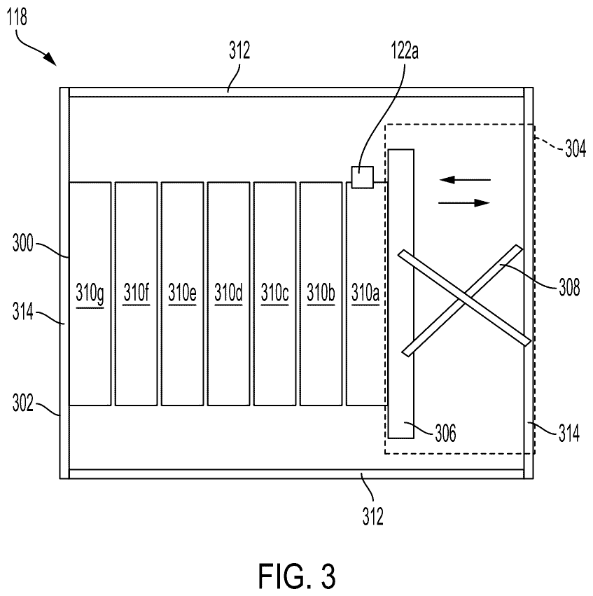

In some aspects, the variable compression battery pack system 100 may further include one or more pressure sensors 122. The one or more pressure sensors 122 may be electrically connected to the ECU 106 and coupled to the battery pack 118, the cell stack 300 (marked in FIG. 3), and/or other components of the battery pack 118. In examples, the variable compression battery pack system 100 may include a plurality of pressure sensors (e.g., with at least one pressure sensor being coupled to a cell in the cell stack 300 of the battery pack 118).

The one or more pressure sensors 122 may be coupled to a surface of the cell stack 300. For example, the one or more pressure sensors 122 may include a first pressure sensor 122a coupled to a first cell 310a in the cell stack 300. In other aspects, the one or more pressure sensors 122 may include one or more second pressure sensors coupled to a last cell 310g in the cell stack 300 (in examples, the one or more pressure sensors 122 may be coupled to other portions and/or components of the cell stack 300 or battery pack 118 such as a second cell 310b, end plate 306, etc.). In examples, the one or more pressure sensors 122 may be positioned between the end plate 306 and the cell stack 300. In another example, one of the one or more pressure sensors 122 may make contact with the first cell 310a or two pressure sensors 122 may make contact with the first cell 310a and last cell 310g. The pressure sensors 122 make contact with the cells so that they can capture live data of the pressure being exerted on the cells in the cell stack 300. The one or more pressure sensors 122 may be and/or include one or more resistive pressure sensors, one or more capacitive pressure sensors, and/or one or more piezoelectric sensors, for example (in examples, the one or more pressure sensors 122 may be and/or include a different type of pressure sensor).

The one or more pressure sensors 122 may be configured to measure, detect, and/or determine pressure applied to a battery cell. For example, the one or more pressure sensors 122 may be configured to measure, detect, and/or determine pressure data corresponding to pressure applied to the one or more pressure sensors 122 that are coupled to the battery cells in the cell stack 300.

The pressure data may indicate a total pressure on the one or more pressure sensors 122 applied to the cell stack 300. The total pressure may be based on an amount of force exerted on the one or more pressure sensors 122, for example. In examples, the ECU 106 may be configured to determine the total pressure based on the pressure data. The pressure data may indicate a size (e.g., in square centimeters (cm\hat{ }2)) of a pressured area on the one or more pressure sensors 122. The pressured area may be an area (or portion) of the one or more pressure sensors 122 that is pressed by variable compression mechanism 304 (shown in FIG. 3). In examples, the ECU 106 may be configured to determine the size and/or shape of the pressured area based on the pressure data.

In some embodiments, the variable compression battery pack system 100 may further include one or more temperature sensors. The temperature sensors may be coupled to a cell stack 300, a battery pack 118, and/or to the interior or exterior of the vehicle 102. In examples, the variable compression battery pack system 100 may include a plurality of temperature sensors. The temperature sensors may measure, detect, and/or determine a temperature of the battery pack 118, the cell stack 300, the interior of the vehicle 102, and/or the exterior of the vehicle 102. The temperature readings may be used by the ECU as one aspect of determining a compressive load input to exert on the battery cells in the cell stack 300.

The variable compression battery pack system 100 may further include the one or more cameras 116. The one or more cameras 116 may be coupled to an exterior of the vehicle 102 and/or an interior of the vehicle 102 such that the one or more cameras 116 look out toward a surrounding area of the vehicle 102. The one or more cameras 116 may be and/or include one or more of an analog camera, a digital camera, a thermal camera, and/or a night vision camera (e.g., utilizing active illumination and/or image intensification). The one or more cameras 116 may provide, capture, and/or record images and/or real-time video of the surrounding area of the vehicle 102. In examples, the one or more cameras 116 (e.g., via the ECU 106) may also have pattern recognition capabilities to view the surrounding area and identify, for example, vehicles, components of vehicles (e.g., a license plate, a side view mirror, vehicle lamps, etc.), road signs (e.g., speed limit signs), and/or writing (e.g., letters, numbers, symbols, etc.) on the vehicles and/or the road signs.

The variable compression battery pack system 100 may further include the battery pack 118. The battery pack 118 may include a compression mechanism, one or more battery modules, and/or a power management system (BMS). The one or more battery modules may each include one or more cells (e.g., cells 310 shown in FIGS. 3-5). The one or more cells may be cylindrical cells, prismatic cells, and/or pouch cells (in examples, other types of cells may be used). A chemistry of the one or more cells may be lithium ion (Li-Ion), nickel manganese cobalt (NMC), nickel metal hydride (Ni—MH), lithium sulfur (Li—S), and/or lead-acid (in examples, other chemistries may be used).

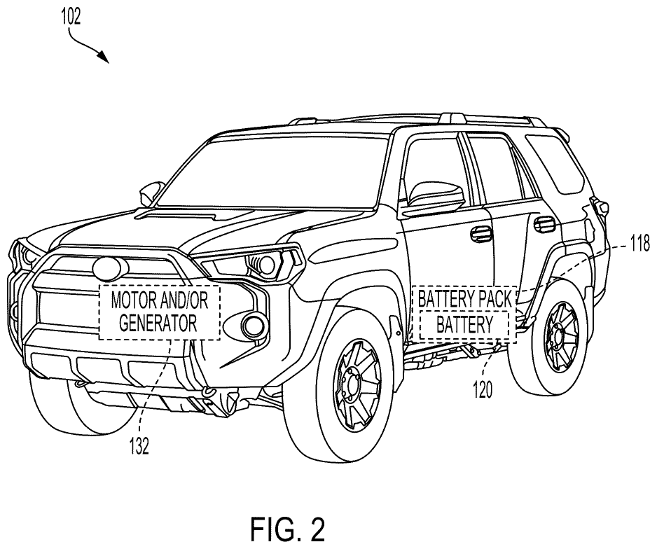

FIG. 2 illustrates an example vehicle 102 in which an example battery pack 118 may be implemented. The battery pack 118 may be retrofitted, coupled to, include, or be included within the vehicle 102 or separate from the vehicle 102. The vehicle 102 may include a motor and/or generator 104 and a battery 120. The motor and/or generator 104 may be located within an engine bay of the vehicle 102. In examples, the motor and/or generator 104 may be located at and/or adjacent to one or more axles of the vehicle 102 such that the vehicle 102 includes one motor and/or generator 104 or a plurality of motors and/or generators.

The battery 120 may be retrofitted, coupled to, include or be included within the vehicle 102. The battery 120 may be electrically connected to the motor and/or generator 104 and/or other components of the vehicle 102. The battery 120 may store chemical energy for later conversion to electrical energy. The battery 120 may provide the electrical energy to and/or receive electrical energy from the motor and/or generator 104 and/or other components of the vehicle 102.

In examples, the vehicle 102 may include a plurality of batteries and/or a plurality of battery packs. The battery pack 118 may be coupled to a chassis and/or a body of the vehicle 102. The battery pack 118 may be positioned at, along, and/or proximate to an undercarriage of the vehicle 102, for example. In examples, the battery pack 118 may be positioned underneath a bed floor of the vehicle 102 (e.g., in instances where the vehicle 102 is a pickup truck) and/or other locations within or on top of the vehicle 102 (e.g., underneath a hood of the vehicle 102, on top of a roof of the vehicle 102, within a trunk of the vehicle 102, etc.). The battery pack 118 may be configured to house and/or protect the battery 120. The battery pack 118 may further house or include electrical components (e.g., electrical connectors and/or wires) configured to electrically couple the battery 120 to the vehicle 102. The battery pack 118 may protect the battery 120 from physical damage, heat, cold, water, and/or moisture, for example. The battery pack 118 may be waterproof. Moreover, the battery pack 118 may provide structural support for the battery 120 and/or may couple the battery 120 to the vehicle 102.

FIGS. 3 and 4 depict examples of the variable compression battery pack system 100 incorporating a variable compression mechanism 304. With combined reference to FIGS. 1 and 3-4, the battery pack 118 may include a cell stack 300 (including one or more battery cells 310a-g) and a frame 302 encompassing the contents of the battery pack 118. The cell stack 300 may include a first battery cell 310a, a second battery cell 310b, a third battery cell 310c, a fourth battery cell 310d, a fifth battery cell 310e, a sixth battery cell 310f, and a seventh battery cell 310g. The battery cells 310a-g may be of various types of battery cells, such as a stacked prismatic cell or rolled prismatic cell. The battery cells 310a-g may expand and contract within the battery pack 118, for example based on a vehicle charging status, a temperature inside and/or outside the vehicle, and/or when the vehicle is accelerating or decelerating.

The frame 302 may have a rectangular shape as shown in FIG. 3 (in examples, the frame 302 may have a square or other shape). The frame 302 may form four walls (or sides) (also referred to herein as a “rigid member”) of the battery pack 118. The frame 302 may define a cavity for holding at least one vehicle battery (e.g., the battery 120) and the variable compression mechanism 304. The frame 302 may include one or more pack sides 312 and/or one or more pack ends 314. The one or more pack sides 312 may include two pack sides. For example, the one or more pack sides 312 may include a front pack side and a rear pack side. As shown in FIG. 3, the one or more pack sides 312 may form two walls (or sides) of the frame 302 and/or the battery pack 118. The one or more pack sides 312 may be positioned between the one or more pack ends 314. Moreover, the one or more pack sides 312 may be configured to couple to the one or more pack ends 314 to form four walls of the frame 302 and/or the battery pack 118.

In some aspects, the one or more pack sides 312 and the one or more pack ends 314 may be formed by casting and/or Computer Numerical Control (CNC) machining a material, such as aluminum or steel (in examples, the one or more pack sides 312 and the one or more pack ends 314 may be made of different metals and/or by different processes). For example, a casting may be produced and then machined with a CNC machine to form the one or more pack sides 312 and the one or more pack ends 314 (in examples, a casting may form the one or more pack sides 312 and the one or more pack ends 314 without being machined). The one or more pack sides 312 and the one or more pack ends 314 may be in the shape of a rectangular bar (or beam) (in examples the one or more pack sides 312 and the one or more pack ends 314 may be in the shape of a square bar or a different elongate shape).

The battery pack 118 may further include a variable compression mechanism 304. The variable compression mechanism 304 may include an end plate 306 and a machine press, shown as mechanical press 308 in FIG. 3 and hydraulic press 400 in FIG. 4, that can expand and contract to compress the cells in cell stack 300 in the pack 118 based on a load input. The mechanical press 308 or hydraulic press 400 may be mounted to the end plate 306. The end plate 306 can evenly distribute a compressive load over the whole surface area of a prismatic (or other type) cell (e.g., cells 310a-g). The cell stack 300 may be positioned in the pack 118 with one side against a frame 302 and the other side against the variable compression mechanism 304, such that, when extended, the press can push the end plate 306 against the cell stack 300.

As shown in FIG. 3, the mechanical press 308 may include a mechanical scissor lift style that utilizes interconnected, hinged arms that can extend to push the end plate 306 against the cell stack 300 to increase pressure or contract to allow the cells 310a-g to expand, releasing pressure. Therefore, when the press 308 is extended, the compressive load exerted on the cells 310a-g will increase. On the contrary, when the press 308 is retracted, the compressive load on the cells 310a-g will decrease.

As shown in FIG. 4, the hydraulic press 400 may include a hydraulic piston. The hydraulic press 400 may use a hydraulic piston which can use pressurized fluid to push against the piston and forcing the piston to move, allowing the hydraulic press 400 to push against the end plate 306. Therefore, when the press 400 is extended, the compressive load exerted on the cells 310a-g will increase. On the contrary, when the press 400 is retracted, the compressive load on the cells 310a-g will decrease. In some aspects, the hydraulic piston may be like that used in a brake caliper.

The mechanical press 308 and hydraulic press 400 may be powered by a motor. The motor may provide power to the mechanical press 308 and hydraulic press 400 so that they may expand and contract. The motor may be a rotational motor. The motor may be positioned adjacent to the mechanical press 308 or hydraulic press 400 within the battery pack 118 to provide power. However, in some embodiments, the motor may be positioned outside of the battery pack 118 to allow for easier access to the motor in the event repairs may be needed, which can avoid the need to replace the entire battery when conducting repairs.

The end plate 306 may have a rectangular shape (in examples, the end plate 306 may have a square or other shape). The end plate 306 may correspond to the same shape (of a smaller size) as the frame 302 of the battery pack 118. However, other shapes may also be possible. The end plate 306 may be formed by casting and/or Computer Numerical Control (CNC) machining a material, such as aluminum, iron, or steel (in examples, the end plate 306 may be made of different metals and/or by different processes). In other aspects, the end plate 306 may also be made out of stamped steel or resins, such as Nylon for lower load applications.

The battery pack 118 may further include one or more pressure sensors 122. The pressure sensors 122 may detect an amount of pressure on the cell stack 300 and/or on the end plate 306. The pressure sensors 122 should make contact with at least one of the cells 310a-g to have live data of the current pressure on the cells 310a-g. In one aspect, the pressure sensors 122 may be positioned between the end plate 306 and the cells 310a-g. In one aspect, one of the pressure sensors 122 may make contact with the first cell 310a, as shown in FIG. 3. In one aspect, two of the pressure sensors 122 may make contact with the first cell 310a and the seventh cell 310g. The pressure sensors 122 can transmit the detected pressure data to the ECU.

The various components of the battery pack 118 may be electronically connected to an ECU (e.g., ECU 106 of FIG. 1). The ECU can determine an appropriate compressive load to apply to the cells 310a-g. The compressive load may depend on the type of cells used in the cell stack 300. The type of cells used may be manually input, automatically detected, and/or hard coded when the vehicle is designed so that the ECU can determine and/or identify the type of cells in the battery pack 118. Accordingly, the ECU can determine how to apply compression for each type of cell. Different types of cells may need different settings for compression. For example, one type of cell may have a minimum or maximum amount of compression that it can withstand that is different from another type of cell. The compressive load may also depend on a current state of the vehicle (e.g., vehicle is charging, vehicle is fast charging, vehicle is accelerating, vehicle is decelerating, etc.) and/or on the detected amount of pressure on the cell stack 300, as determined by the pressure sensors 122.

The ECU can determine changes in pressure (e.g., via the pressure sensors 122) by monitoring the pressure data from the pressure sensors 122. In some aspects, the ECU may determine a desired level of pressure based on the use case. For example, if the vehicle is currently fast charging, a decreased level of pressure may be desired as fast charging may cause the cells to expand. Decreasing the pressure during fast charging can minimize lithium deposition risk which can result in faster charging times and optimized cell life. The ECU can evaluate that the desired level of pressure is higher than the current level of pressure from the pressure sensors 122 and cause the compression mechanism 304 to increase pressure on the cell stack 300 by expanding the press. On the other hand, if the vehicle is discharging, a decreased level of pressure may be desired. In this case, the ECU can evaluate that the desired level of pressure is lower than the current level of pressure from the pressure sensors 122 and cause the compression mechanism 304 to decrease pressure on the cell stack 300 by compressing the press.

In some aspects, the battery pack 118 may be a hybrid pack. As opposed to existing hybrid packs which use one or more shims to set the required load, the present hybrid pack may replace the shim and instead can expand to close the gap and apply the required load. Existing hybrid packs may start out as a metal tub that can be filled with rectangular batteries and spacers. Once the correct number of batteries and spacers have been added, a shim can be inserted to set the initial load. The shim size may change depending on the tolerance of the cells and spacers, so an assembly plant needs to stock multiple sizes. The present hybrid packs would eliminate that shim and its variations by accurately setting the required load as measured by the pressure sensors 122.

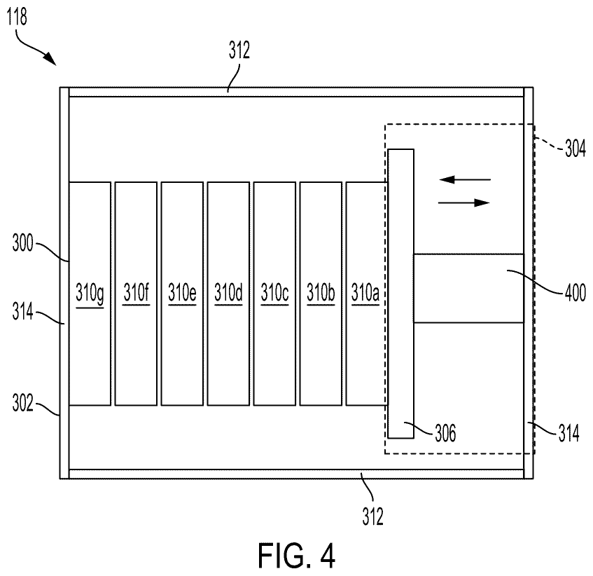

FIG. 5 is an example variable compression battery pack system 100 that incorporates one or more bands utilizing the compression mechanism. Referring to FIG. 5 with continuing reference to FIGS. 1 and 3, the variable compression battery pack system 100 may include a cell stack 300 (including one or more battery cells 310a-n) and bands 500a-c that can expand and contract to compress the cells in cell stack 300 in the variable compression battery pack system 100 based on a compressive load input. The bands 500a-c may be coupled to end plates 306a-b, where a first side of each of the bands 500a-c is coupled to end plate 306a and a second side of each of the bands 500a-c is coupled to end plate 306b and the cells 310a-n are positioned between end plate 306a and 306b. The end plates 306a-b can evenly distribute the compressive load over the whole surface area of a prismatic cell.

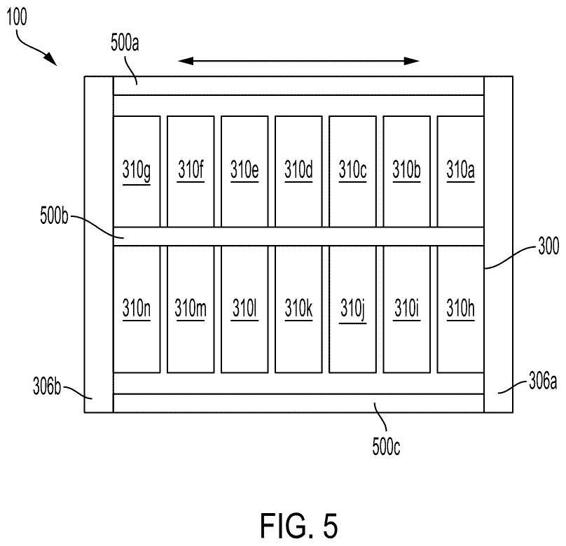

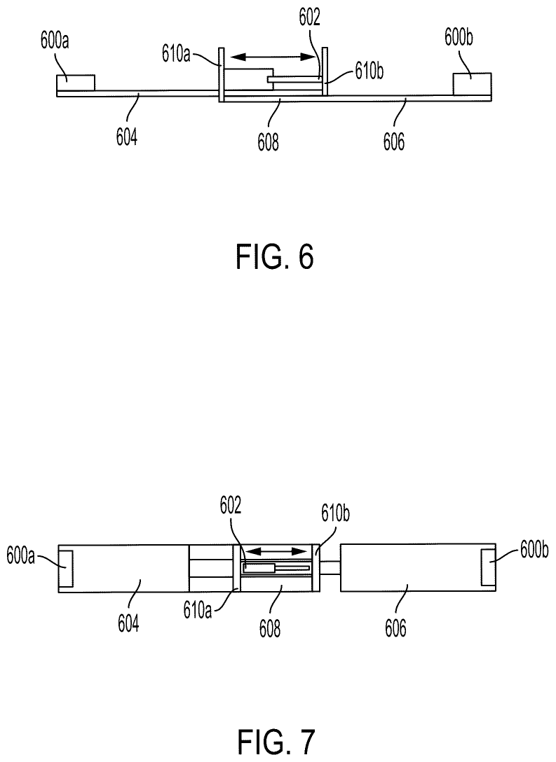

The variable compression battery pack system 100 of FIG. 5 includes bands 500a-c that utilize a compression mechanism built into the bands 500a-c. A more detailed view of the compression mechanism built into the bands is shown in FIGS. 6-7. In this way, the cell stack 300 can be compressed and decompressed independently of the battery pack 118 as the cells are encompassed and held in place by the bands 500a-c and the end plates 306a-b (as opposed to relying on a portion of the frame to house the cells). This would allow the variable compression battery pack system 100 to be included into battery packs that do not have the compression mechanism built in. The compression mechanism can be added to one or more of the bands 500a-c. In one aspect, the compression mechanism can be added to a single band, with the other bands acting as sliders to allow the cells to expand and contract.

The battery cells 310a-g may be positioned between end plate 306a and end plate 306b on either side and between band 500a and band 500b on the top and bottom, respectively. Typically, for prismatic cells, the cells are stacked horizontally. For pouch cells, the cells may be stacked either horizontally or vertically. Then, the battery cells 310h-n may be positioned between end plate 306a and end plate 306b on either side and between band 500b and band 500c on the top and bottom, respectively. Therefore, when the bands 500a-c compress, the end plates 306a-b can put pressure on the cell stack 300. The compression mechanism can be controlled by an ECU, as described above.

FIG. 6 is a side view and FIG. 7 is a top view of a portion of FIG. 5 illustrating a vehicle band design incorporating an electromechanical or hydraulic actuator 602 to control compression and expansion of the bands. The band design of FIGS. 6 and 7 may include one or more contact plates (also referred to herein as end plates) 600a-b, a two-piece band top 604, a two piece band bottom 606, and a top/bottom band locking and sliding mechanism 608. The band top 604 may be coupled to the band bottom 606 via the top/bottom band locking and sliding mechanism 608, with the band top 604 overlapping the band bottom 606 beneath (or otherwise above or adjacent to) the locking and sliding mechanism 608. The band bottom 606 may be coupled to a locking and sliding mechanism side wall 610a. The band top 604 may be coupled to a locking and sliding mechanism side wall 610b. The compression mechanism can be added to just two sides of the cell stack or to all four sides depending on need. In the case that the mechanism is only added to two sides, the other two bands act as sliders to allow the module to expand and contract.

The locking and sliding mechanism 608 can use an electromechanical or hydraulic actuator 602 (or other form of mechanical press) to control compression and expansion. For example, if the electromechanical or hydraulic actuator 602 pushes on the side walls 610a-b, it will cause the band top 604 and the band bottom 606 to stretch and pull on the contact plates 600a-b. The contact plates 600a-b may be placed on either side of a cell stack. Therefore, the contact plates 600a-b may compress on the cell stack and increase the pressure on the cell stack. On the other hand, if the electromechanical or hydraulic actuator 602 contracts, it will cause the band top 604 and the band bottom 606 to relax and release on the contact plates 600a-b. Therefore, the contact plates 600a-b may decompress on the cell stack and decrease the pressure on the cell stack.

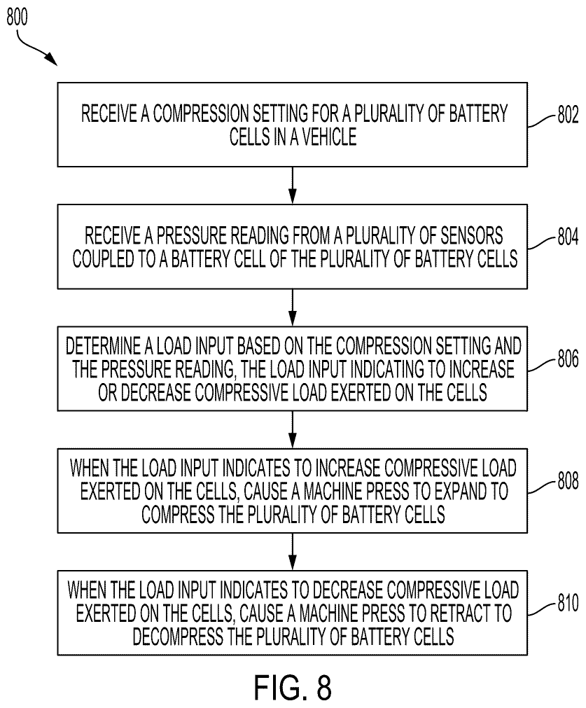

FIG. 8 is a flowchart illustrating a process 800 for expanding and contracting compression on battery cells in a vehicle according to an aspect of the disclosure. One or more computers or one or more data processing apparatuses, for example, the ECU 106 of the variable compression battery pack system 100 of FIG. 1, appropriately programmed, may implement the process 800. The process 800 of the disclosure, however, is not limited to use of the exemplary variable compression battery pack systems of FIGS. 1-7.

The process 800 begins at block 802 where the variable compression battery pack system 100 may receive a compression setting for a plurality of battery cells in a vehicle. The plurality of battery cells may be clustered in a cell stack. The battery cells may be of various types, such as stacked prismatic cell or rolled prismatic cell. Each type may have a different compression setting that is appropriate for that type of cell. The compression setting may be manually input to the ECU, hard-coded, or detected based on the type of cell and passed to the ECU.

At block 804, the variable compression battery pack system 100 may receive a pressure reading from a plurality of sensors coupled to a battery cell of the plurality of battery cells. The plurality of sensors may be coupled to one or more battery cells in the cell stack and/or to a variable compression mechanism. The sensors may be configured to detect pressure on the cell stack. For example, the sensors may be pressure sensors 122 as described in FIG. 1. The sensors may transmit the pressure readings from the cell stack to the ECU.

At block 806, the variable compression battery pack system 100 may determine a load input based on the compression setting and the pressure reading, the load input indicating to increase or decrease compressive load exerted on the cells. For example, if the pressure reading indicates the pressure on the cells is currently high, the variable compression battery pack system 100 may determine that the load input should be a decrease in pressure, depending on the compression setting of the battery cell. In some aspects, the load input may be further based on a charging status (e.g., vehicle is currently fast charging) of the vehicle and/or based on detected temperatures (e.g., via one or more temperature sensors) within the battery pack and/or external to the vehicle.

At block 808, when the load input indicates to increase compressive load exerted on the cells, the variable compression battery pack system 100 may cause a machine press to expand to compress the plurality of battery cells. The battery cells may be housed in a battery pack and positioned between a rigid member of the battery pack and a variable compression mechanism, where the variable compression mechanism includes the machine press and an end plate that can apply pressure to the cells. The machine press may be mechanical press or a hydraulic piston press.

At block 810, when the load input indicates to decrease compressive load exerted on the cells, the variable compression battery pack system 100 may cause a machine press to expand to decompress the plurality of battery cells. In some aspects, the machine press may be powered by a motor. The motor may be located external to the battery pack.

In some aspects, the variable compression battery pack system 100 may include one or more metal bands that can restrain the battery cells as they expand and contract. The metal bands may be controlled by a machine press to expand and contract. The metal bands may include a top band and a bottom band, where a portion of the top band and a portion of the bottom band may overlap and are connected to a locking and sliding mechanism. The metal bands may be coupled to an end plate on either side that can press on the cells in between. The locking and sliding mechanism may include the machine press and can control the expansion and contraction of the bands. The machine press may be an electromechanical or hydraulic actuator.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for expanding and contracting compression on battery cells in a vehicle, comprising:
a plurality of battery cells in a cell stack;
a variable compression mechanism comprising:
a machine press configured to expand and retract to compress and decompress one or more battery cells based on a compressive load, and
an end plate configured to evenly distribute the load over a surface area of the one or more battery cells, the machine press being connected to the end plate, and the end plate being mounted to the one or more battery cells;
a battery pack formed in the shape of a rectangle and defining a cavity for holding the cell stack and the variable compression mechanism;
a plurality of sensors coupled to the cell stack and the variable compression mechanism configured to detect pressure on the cell stack; and
an electronic control unit (ECU) electronically connected to the cell stack, the variable compression mechanism, and the plurality of sensors, configured to:
receive a compression setting for the plurality of battery cells,
receive a pressure reading from the plurality of sensors,
determine a compressive load input based on the compression setting and the pressure reading, the load input indicating to increase or decrease compressive load exerted on the cells,
when the load input indicates to increase compressive load exerted on the cells, cause the machine press to expand to compress the plurality of battery cells in the cell stack, and
when the load input indicates to decrease compressive load exerted on the cells, cause the machine press to retract to decompress the plurality of battery cells in the cell stack.

2. The system of claim 1, wherein the variable compression mechanism further comprises:
a second end plate configured to evenly distribute the load over a surface area of the one or more battery cells; and
one or more metal bands coupled to the end plate and the second end plate and configured to restrain the one or more battery cells as the one or more battery cells expand and contract, wherein the machine press controls the expansion and contraction of the one or more metal bands.

3. The system of claim 2, wherein the one or more metal bands comprise a top band and a bottom band, wherein a portion of the top band and the bottom band overlap and are connected to a locking and sliding mechanism to control the expansion and contraction of the top band and the bottom band, wherein the locking and sliding mechanism includes the machine press.

4. The system of claim 3, wherein the machine press is an electromechanical or hydraulic actuator to control the compression and expansion of the top band and the bottom band.

5. The system of claim 1, further comprising a plurality of temperature sensors configured to detect temperatures within the battery pack and external to the vehicle, wherein the load input is further based on the detected temperatures.

6. The system of claim 1, wherein the load input is further based on a charging status of the vehicle.

7. The system of claim 1, wherein the compression setting is received from user input or hard coded based on a type of the plurality of battery cells.

8. The system of claim 7, where in the type of the plurality of battery cells comprises stacked prismatic cell, rolled prismatic cell, or pouch cell.

9. The system of claim 1, wherein the machine press comprises a mechanical press or a hydraulic piston press.

10. The system of claim 1, wherein the machine press is powered by a motor, wherein the motor is located external to the battery pack.

11. A variable compression battery cell pack for a vehicle battery in a vehicle, comprising:
a plurality of battery cells in a cell stack;
a variable compression mechanism comprising:
a machine press configured to expand and retract to compress and decompress one or more battery cells based on a compressive load, and
an end plate configured to evenly distribute the load over a surface area of the one or more battery cells, the machine press being connected to the end plate, and the end plate being mounted to the one or more battery cells;
a battery pack formed in the shape of a rectangle and defining a cavity for holding the cell stack and the variable compression mechanism;
a sensor coupled to the cell stack configured to detect pressure on the cell stack; and
an electronic control unit (ECU) electronically connected to the cell stack, the variable compression mechanism, and the sensor, configured to:
receive a compression setting for the plurality of battery cells,
receive a pressure reading from the sensor,
determine a compressive load input based on the compression setting and the pressure reading, the load input indicating to increase or decrease compressive load exerted on the cells,
when the load input indicates to increase compressive load exerted on the cells, cause the machine press to expand to compress the plurality of battery cells in the cell stack, and
when the load input indicates to decrease compressive load exerted on the cells, cause the machine press to retract to decompress the plurality of battery cells in the cell stack.

12. The variable compression battery cell pack of claim 11, wherein the variable compression mechanism further comprises:
a second end plate configured to evenly distribute the load over a surface area of the one or more battery cells; and
one or more metal bands coupled to the end plate and the second end plate and configured to restrain the one or more battery cells as the one or more battery cells expand and contract, wherein the machine press controls the expansion and contraction of the one or more metal bands.

13. The variable compression battery cell pack of claim 12, wherein the one or more metal bands comprise a top band and a bottom band, wherein a portion of the top band and the bottom band overlap and are connected to a locking and sliding mechanism to control the expansion and contraction of the top band and the bottom band, wherein the locking and sliding mechanism includes the machine press.

14. The variable compression battery cell pack of claim 13, wherein the machine press is an electromechanical or hydraulic actuator to control the compression and expansion of the top band and the bottom band.

15. The variable compression battery cell pack of claim 11, further comprising a plurality of temperature sensors configured to detect temperatures within the battery pack and external to the vehicle, wherein the load input is further based on the detected temperatures.

16. The variable compression battery cell pack of claim 11, wherein the load input is further based on a charging status of the vehicle.

17. The variable compression battery cell pack of claim 11, wherein the compression setting is received from user input or hard coded based on a type of the plurality of battery cells.

18. The variable compression battery cell pack of claim 17, where in the type of the plurality of battery cells comprises stacked prismatic cell, rolled prismatic cell, or pouch cell.

19. The variable compression battery cell pack of claim 11, wherein the machine press comprises a mechanical press or a hydraulic piston press.

20. A vehicle including a system for expanding and contracting compression on battery cells in the vehicle, the vehicle comprising:
a plurality of battery cells in a cell stack;
a variable compression mechanism comprising:
a machine press configured to expand and retract to compress and decompress one or more battery cells based on a compressive load, and
an end plate configured to evenly distribute the load over a surface area of the one or more battery cells, the machine press being connected to the end plate, and the end plate being mounted to the one or more battery cells;
a battery pack formed in the shape of a rectangle and defining a cavity for holding the cell stack and the variable compression mechanism, the cell stack being positioned in the battery pack between a rigid member and the variable compression mechanism;
a plurality of sensors coupled to the cell stack and the variable compression mechanism configured to detect pressure on the cell stack; and
an electronic control unit (ECU) electronically connected to the cell stack, the variable compression mechanism, and the plurality of sensors, configured to:
receive a compression setting for the plurality of battery cells,
receive a pressure reading from the plurality of sensors,
determine a compressive load input based on the compression setting and the pressure reading, the load input indicating to increase or decrease compressive load exerted on the cells,
when the load input indicates to increase compressive load exerted on the cells, cause the machine press to expand to compress the plurality of battery cells in the cell stack, and
when the load input indicates to decrease compressive load exerted on the cells, cause the machine press to retract to decompress the plurality of battery cells in the cell stack.
